(19) United States
(12) Patent Application Publication
(10) Pub. No.: US 2006/0154694 A1
(43) Pub. Date: Jul. 13, 2006

(54) Image forming apparatus and control method thereof

(75) Inventor: Eog-kyu Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/252,561

(22) Filed: Oct. 19, 2005

(30) Foreign Application Priority Data
Dec. 16, 2004 (KR) KR2004-106842

(51) Int. Cl. H04B 1/38

(52) U.S. Cl. 455/557

(57) ABSTRACT

An image forming apparatus and a control method thereof are provided where a modem unit modulates a certain signal and converts and outputs the signal in a digital form, a level controller varies the voltage level of the signal output from the modem unit, a line unit detects the voltage level of the varied signal and transmits the varied signal to an external device through a public switched telephone network PSTN. A controller adjusts the voltage level of the signal output from the modem unit by controlling the level controller according to the result of the comparison between the voltage level value of the signal detected by the line unit and a predetermined reference value. Accordingly, an optimal voltage level of a signal transmitted from a main unit to a line unit is maintained.

### CROSS-REFERENCE TO RELATED APPLICATIONS

This application claims benefit under 35 U.S.C. § 119 from Korean Patent Application No. 2004-106842 filed on Dec. 16, 2004 in the Korean Intellectual Property Office, the entire disclosure of which is hereby incorporated by reference.

### BACKGROUND OF THE INVENTION

1. Field of the Invention

The present invention relates to an image forming apparatus and a control method thereof. More specifically, the present invention relates to an image forming apparatus and a control method thereof, in which the optimal voltage level of a signal transmitted from a main unit to a line unit is maintained.

2. Description of the Related Art

Generally, an image forming apparatus such as a facsimile machine or a multifunction device containing a facsimile function is connected to a public switched telephone network (PSTN) in order to send and receive fax data and voice data.

FIG. 1 is a block diagram showing a configuration of a conventional facsimile.

Referring to FIG. 1, a conventional facsimile 100 comprises a main unit 110, a data transmission unit 130, and a line unit 150.

The main unit 110 includes a controller 111, a modem 113, and a line interface 115, and controls all the operations of the facsimile machine 100 scanning a document and processing the data to be transmitted to a counterpart facsimile machine (not shown).

The controller 111 transfers the scanned image data to the line unit 150 through the modem 113 and the line interface 115.

The line unit 150 contains a Direct Access Arrangement (DAA) block (not shown). The DAA block (not shown) converts a digital data transferred from the main unit 110 into an analog data, and calls to a counterpart facsimile and transmits the analog data. Conversely, the DAA block receives a call from a counterpart facsimile (not shown), converts an analog data into a digital data, and transfers the digital data to the main unit 110. Recently, an Integrated Circuit (IC) chip integrating the DAA block has been used.

The main unit 110 and the line interface 115 preferably use different circuit boards or separate the grounds on a circuit board in order to use different reference electric potentials. The reason for this is to cut off the noise of high voltage flowing into the main unit 110, the noise coming into the line unit 150 from the PSTN, thereby protecting a facsimile 100 and a user of the facsimile.

The data transmission unit 130 provided between the main unit 110 and the line unit 150 transfers a data signal shown in FIG. 2 and a clock signal, and is embodied by a condenser or a transformer.

FIG. 3 shows an example of a data signal waveform transmitted between the main unit 110 and the line unit 150 through the data transmission unit 130.

The modem 113 of the main unit 110 and the DAA block (not shown) of the line unit 150 always transmit a data signal and a clock signal through the data transmission unit 130. The data signal and the clock signal have a pulse waveform shown in FIG. 3. The data signal has a frequency of more than 2 MHz, and the clock signal has a high frequency of more than 4 MHz. However, such a high frequency component of over several MHz is induced in the whole line unit in addition to an interface unit (not shown) that is connected to the main unit 110. Consequently, more unwanted noise signals than the reference level that is prescribed as a communication standard are leaked through the telephone line cord connected to the line unit 150, the noise signals having the same frequency component as, and integer times as high as, the induced high frequency. Therefore, due to the unwanted frequency component leaking through a telephone line, the unwanted frequency and electromagnetic interference (EMI) regulations prescribed by each country's communication standards cannot be satisfied.

FIG. 4 is an example of a spectrum measured at a telephone line cord terminal connected to the line unit, showing that a peak value exceeding the reference value A prescribed as a communication standard is detected around 4 MHz.

FIG. 5 is an example of an EMI waveform measured at a telephone line cord terminal connected to the line unit, showing that a peak value exceeding the reference value B prescribed as a communication standard is detected around 140 MHz.

As a general method for solving the above problems, a method of minimizing the spectrum leaked through a telephone line cord terminal is proposed, the method comprises installing a ferrite bead or an inductor at the telephone path and optimizing the voltage level of a data signal at the same time. However, maintaining the optimized data signal level is impossible due to the deviation of the components constituting the data transmission unit which transmits a data signal between the main unit and the line unit.

### SUMMARY OF THE INVENTION

The present invention has been made in order to address the above drawbacks and other problems in the art. An object of the present invention is to provide an image forming apparatus and a control method thereof, in which the optimal voltage level of a signal transmitted from a main unit to a line unit is maintained.

According to one exemplary aspect of the present invention, there is provided an image forming apparatus comprising a modem unit for modulating a certain signal and converting and outputting the signal in a digital form, a level controller for varying the voltage level of the signal output from the modem unit, a line unit for detecting the voltage level of the varied signal and transmitting the varied signal to an external device through a PSTN, and a controller for adjusting the voltage level of the signal output from the modem unit by controlling the level controller according to the result of the comparison between the voltage level value of the signal detected by the line unit and a predetermined reference value.

In an exemplary implementation of the present invention, the apparatus further comprises a storage unit for storing the reference value.

In an exemplary implementation of the present invention, the apparatus further comprises a data transmission unit for transmitting the signal between the modem unit and the line unit.

According to an embodiment of the present invention, the signal can be either a clock signal or a data signal to be transmitted to the external device.

In an exemplary implementation of the present invention, the modem unit comprises a modem for modulating a data signal to be transmitted to the external device and a line interface for converting and outputting the modulated signal in a digital form.

In an exemplary implementation of the present invention, the line unit comprises a voltage detector for detecting the voltage level value of the signal varied through the level controller and a transceiver for sending and receiving the varied signal from the external device through a PSTN.

According to an embodiment of the present invention, the level controller comprise a variable resistor for varying the voltage level of the signal outputted from the modem unit.

In an exemplary implementation of the present invention, the controller increases the voltage level value of the signal outputted from the modem unit by decreasing the resistance value of the variable resistor if the voltage level value of the signal detected by the voltage detector is less than the reference value. In another exemplary implementation of the present invention, the controller decreases the voltage level value of the signal outputted from the modem unit by increasing the resistance value of the variable resistor if the voltage level value of the signal detected by the voltage detector is greater than the reference value.

According to another aspect of the present invention, there is provided a method of controlling the image forming apparatus. The method comprises detecting the voltage level of a certain signal that is modulated by the modem unit and converted and outputted in a digital form, and adjusting the voltage level of the signal according to the result of the comparison between the detected voltage level value and a predetermined reference value.

According to an embodiment of the present invention, the signal is either a clock signal or a data signal to be transmitted to an external device.

In an exemplary implementation of the present invention, the voltage level of the signal can be varied according to the change of the resistance value of the variable resistor.

In another exemplary implementation of the present invention, the step of adjusting the voltage level of the signal comprises increasing the voltage level value of the signal by decreasing the resistance value of the variable resistor if the detected voltage level value is less than the reference value’ and decreasing the voltage level value of the signal by increasing the resistance value of the variable resistor if the detected voltage level value is greater than the reference value.

### BRIEF DESCRIPTION OF THE DRAWINGS

The above aspects and features of the present invention will be more apparent from the following description of certain exemplary embodiments of the present invention with reference to the accompanying drawings, in which like reference symbols indicate the same or similar components, wherein:

FIG. 1 is a block diagram showing a configuration of a conventional facsimile;

FIG. 2 shows an example of a data between a main unit and a line unit of FIG. 1;

FIG. 3 shows an example of a data signal waveform transmitted between the main unit and the line unit through the data transmission unit of FIG. 1;

FIG. 4 shows an example of a spectrum measured at a telephone line cord terminal connected to the line unit;

FIG. 5 shows an example of an EMI waveform measured at a telephone line cord terminal connected to the line unit;

FIG. 6 shows a block diagram of an image forming apparatus according to one embodiment of the invention;

FIG. 7 shows an example of a voltage detector in FIG. 6;

FIG. 8 is a flow chart showing a method of controlling the image forming apparatus according to one embodiment of the invention; and

FIG. 9 shows an example of a spectrum measured at a telephone line connected to the line unit of the image forming apparatus according to the invention.

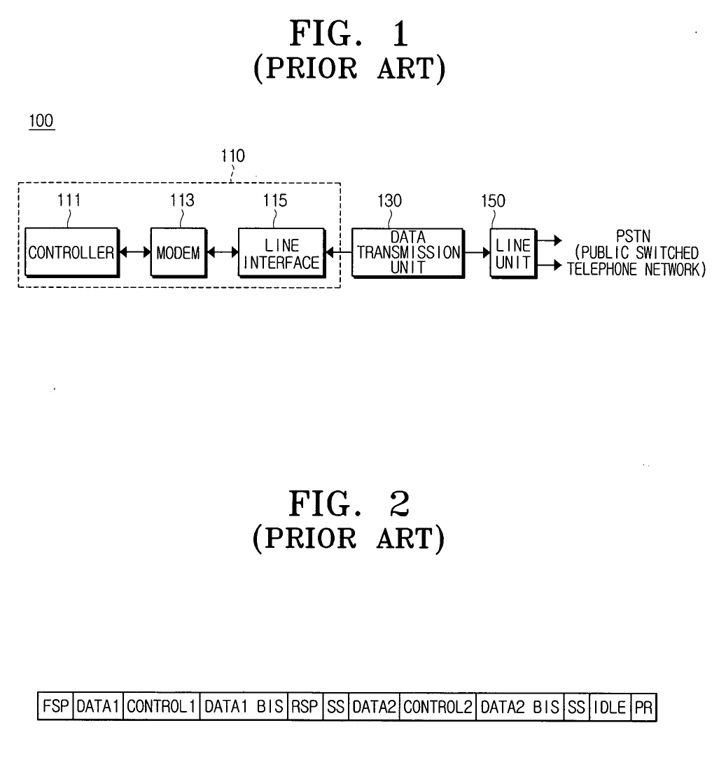

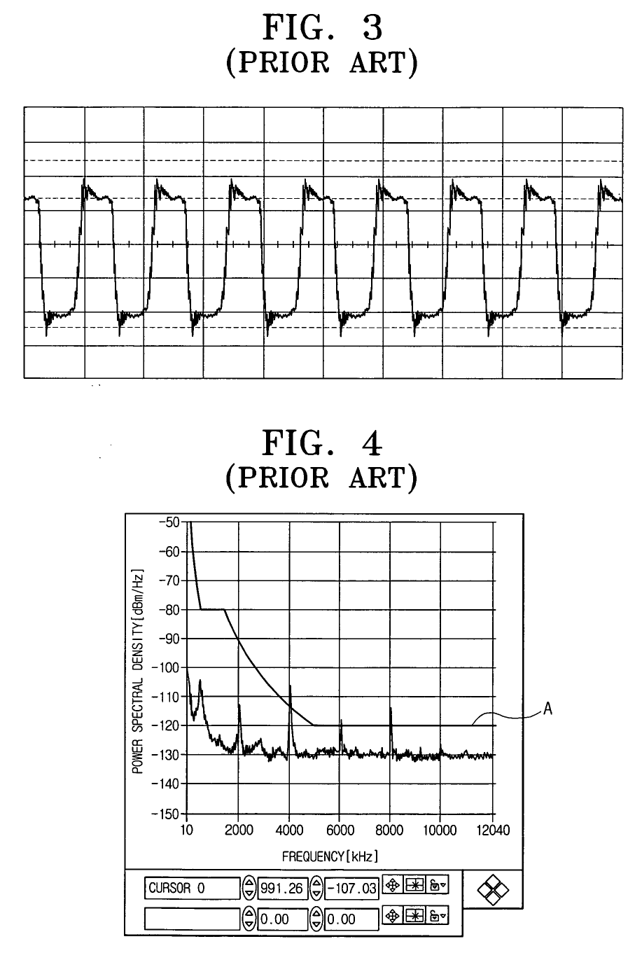

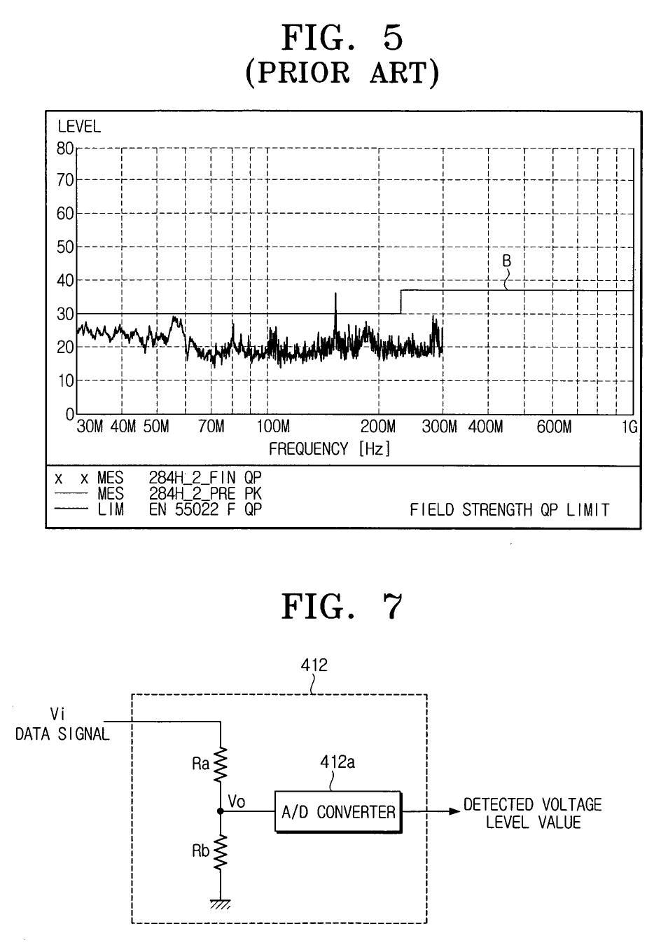

### DETAILED DESCRIPTION OF EXEMPLARY EMBODIMENTS

Certain exemplary embodiments of the present invention will be described in greater detail with reference to the accompanying drawings.

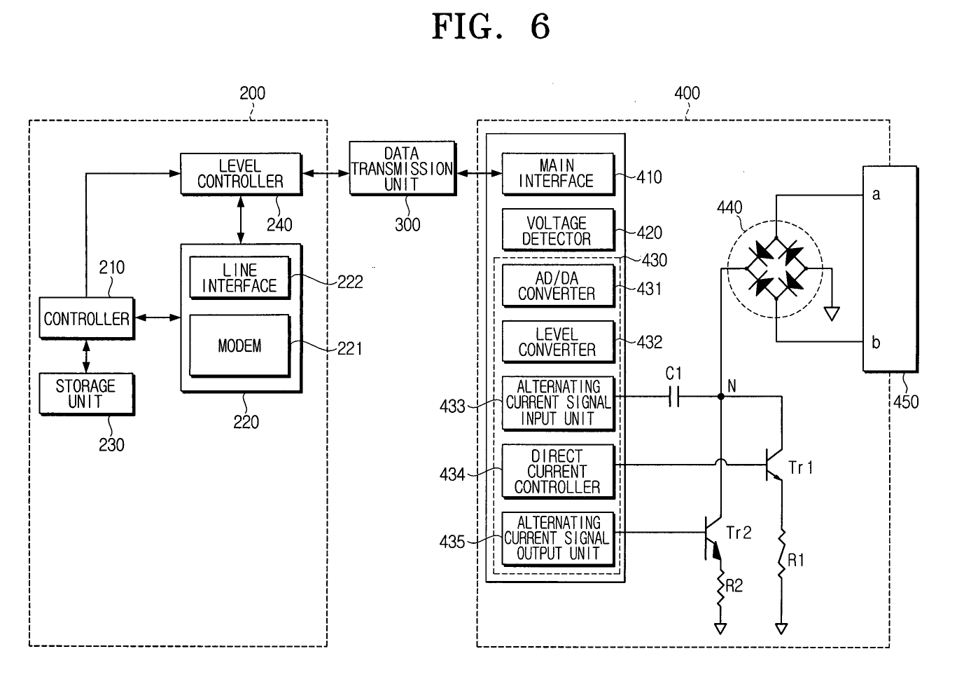

FIG. 6 shows a block diagram of an image forming apparatus according to one exemplary embodiment of the present invention.

Referring to FIG. 6, an image forming apparatus according to one exemplary embodiment of the present invention comprises a main unit 200, a data transmission unit 300, and a line unit 400. The main unit 200 comprises a controller 210, a modem unit 220, a storage unit 230, and a level controller 240. The modem unit 220 comprises a modem 221 and a line interface 222. The line unit 400 comprises a main interface 410, a voltage detector 420, and a transceiver 430. The transceiver 430 comprises an AD/DA converter 431, a level converter 432, an alternating current signal input unit 433, a direct current controller 434, an alternating current signal output unit 435, a bridge diode 440, and a connection terminal 450.

The modem unit 220 modulates and outputs the data signal to be transmitted from the controller 210 to an external device (not shown), and, at the same time, demodulates the data received from the external device (not shown) and outputs to the controller 210. In order to do this, the modem unit comprises a line interface 222 for interfacing to the line unit 400.

The modem 221 is a device for modulating and demodulating data signals in order to perform data communication with an external device (not shown). The line interface 222 transforms the signal output from the modem 221 for data transmission into the digital form of a protocol prior to transmitting to the line unit 400. In addition, the line interface 222 transforms the digital signal outputted from the line interface 400 for data reception into an analog form prior to transmitting to the modem 221.

The level controller 240 varies the voltage level of the data signal output from the modem unit 220 according to the control of the controller 210. In an exemplary implementation of the present invention, the level controller 240 can be embodied using a variable resistor in such a manner that, if the resistance value of the variable resistor is high, the voltage level of the data signal applied to the data transmission unit 300 becomes low, and if the resistance value of the variable resistor is low, the voltage level of the data signal applied to the data transmission unit 300 becomes high.

The storage unit 230 stores various control programs, data generated while the programs are performed, and documents to be printed. The storage unit 230, according to an exemplary embodiment of the present invention, stores in advance as reference values the optimal voltage level values of the data signal and the clock signal transmitted from the main unit 200 to the line unit 400. In an exemplary implementation of the present invention, if the voltage level of the data signal transmitted from the main unit 200 to the line unit 400 is too high, frequency spectrum and EMI problems occur. If the voltage level is too low, the line unit 400 can not recognize and process the data signal, so that reference values calculated considering the problems are stored in the storage unit 230 in advance.

The controller 210 controls general operations of the image forming apparatus. The controller 210 according to an exemplary embodiment of the present invention compares the voltage level value detected by the voltage detector 420 of the line unit 400 with the reference value, increases the voltage level value of the data signal by decreasing the resistance value of the variable resistor if the detected voltage level value is less than the reference value, and decreases the voltage level value of the data signal by increasing the resistance value of the variable resistor if the detected voltage level value is greater than the reference value, so that the voltage level of the data signal transferred to the line unit 400 through the data transmission unit 300 is adjusted so as to be equal to the optimal value.

The data transmission unit 300 located between the main unit 200 and the line unit 400 and embodied by a condenser or a transformer, cuts off the current path in between, and transfers only the data signal and clock signal of a protocol.

The line unit 400 is connected to a PSTN through the connection terminal 450, and transmits the data transmitted from the main unit 200 to the PSTN or transfers the data transmitted from the PSTN to the main unit 200. In an exemplary implementation of the present invention, most of the components of the line unit 400 are embodied in the form of a single chip.

The main interface 410 transfers the data signal transferred from the data transmission unit 300 to the AD/DA converter 431, and transforms the data signal transferred from the AD/DA converter 431 into the data signal of a protocol and transfers to the data transmission unit 300.

The voltage detector 420, which can be mounted inside or outside of the single chip, detects the voltage level value of the data signal transmitted from the data transmission unit 300, and transfers the detected voltage level value to the controller 210 through the main interface 410. FIG. 7 shows an example of the voltage detector 420 according to an exemplary embodiment of the present invention. The voltage detector 420 divides the voltage level Vi of the data signal received from the data transmission unit 300 by the resistor Ra and the resistor Rb, converts the divided voltage level into a digital value Vo by means of the A/D converter, and transfers the digital value to the controller 210 through the main interface 410. In an exemplary implementation of the present invention, the relationship of Vi=((Ra+Rb)/Rb)×Vo is formed, so that the voltage detector 420 can convert Vo into Vi and transfer it to the controller 210. In an exemplary implementation of the present invention, the voltage detector 420 of FIG. 7 is only an example and does not restrict the idea of the invention in so far as the voltage level of the data signal transmitted from the main unit 200 is detectable.

The direct current controller 434 turns on a first transistor Tr1 according to the control of the controller 210 and forms a current path of a certain size between the node N and the ground terminal, so that a PSTN provider can recognize through the PSTN connected to the connection terminal 450 that the image forming apparatus according to an exemplary implementation of the present invention is in a driving state.

In the case where an alternating current signal of a facsimile data or a voice data is applied from the PSTN through the connection terminal 450 and the bridge diode 440, the alternating current signal input unit 433 removes the direct current component at the capacitor C1 and applies the signal to the level converter 432. The level converter 432 amplifies the signal to a certain electric potential level and applies it to the AD/DA converter 431. The AD/DA converter 431 converts the signal received from the alternating current signal input unit 433 into a digital signal and transfers it to the main unit 200 through the main interface 410.

The alternating current signal output unit 435 inputs the data signal into the base terminal of a second transistor Tr2, the data signal being modulated at the modem unit 220 and converted into an alternating current signal at the AD/DA converter 431, and amplifies and transmits the signal to the PSTN through the connection terminal 450.

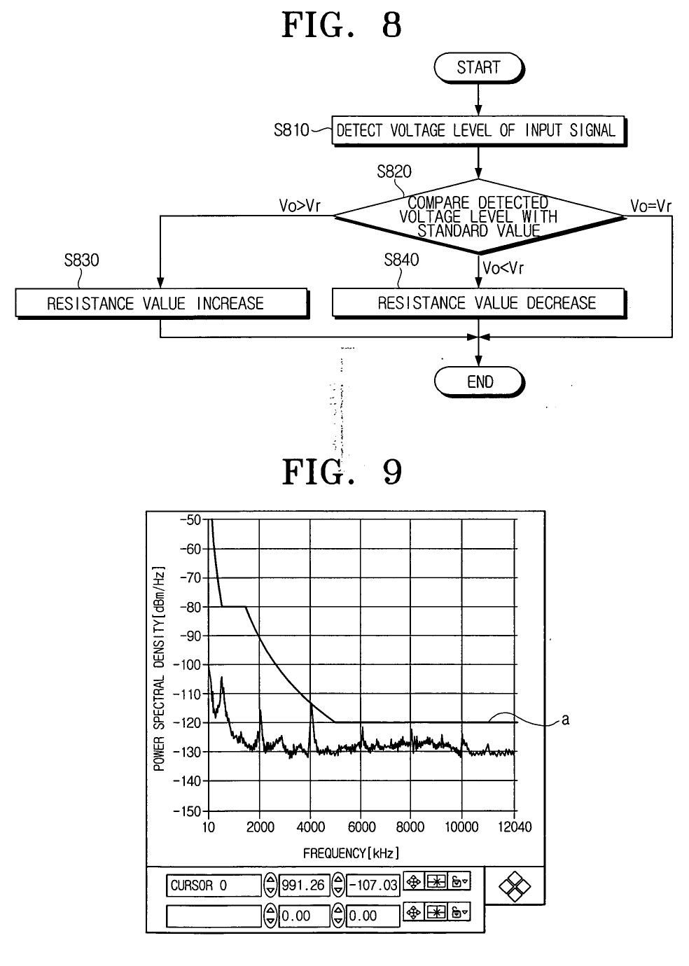

FIG. 8 is a flow chart showing a method of controlling the image forming apparatus according to an exemplary embodiment of the present invention.

Referring to FIGS. 6 and 8, first, the voltage detector 420 detects the voltage level value Vo of the data signal modulated and converted into a digital form at the modem unit 220 at step S810, and provides the value to the controller 210 of the main unit 200.

Thereafter, the controller 210 compares the detected voltage level value of the data signal with the stored reference value Vr stored previously in the storage unit 230 at step S820. If the detected voltage level value Vo is less than the reference value, the controller 210 increases the voltage level value of the data signal by decreasing the resistance value of the variable resistor of the level controller 240 at step S830, and if the detected voltage level value is greater than the reference value, the controller 210 decreases the voltage level value of the data signal by increasing the resistance value of the variable resistor of the level controller 240 at step S840. Accordingly, by making the voltage level of the data signal transmitted from the main unit 200 to the line unit 400 equal to the reference value, the optimal level of the data signal can be maintained.

FIG. 9 is an example of a spectrum measured at the telephone line cord terminal connected to the line unit 400 of the image forming apparatus according to an exemplary implementation of the present invention, showing that the peak value exceeding the reference value A at around 4 MHz in FIG. 4, the reference value being prescribed as a communication standard, is improved to be under the reference value A.

In an exemplary embodiment of the present invention, controlling the voltage level of the data signal to be transmitted to an external device is explained. However, exemplary implementations of the present invention can be constituted such that the optimal voltage level value of the clock signal transferred from the main unit 200 to the line unit 400 is calculated and stored in the storage unit 230 as a reference value in advance, and the voltage detector 420 detects the voltage level value of the clock signal and provides it to the controller 210, so that the voltage level of a clock signal transferred from the level controller 240 to the data transmission unit 300 can be controlled.

As described above, according to exemplary embodiments of the present invention, the variation of the voltage levels of the data signal and the clock signal transferred from the main unit to the line unit may be minimized, the variation being introduced by the deviation of components, so that the optimal voltage level that is predetermined in advance when designing a product can be maintained.

In addition, the frequency spectrum and the EMI characteristic leaked through the telephone line in the line unit can be improved.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image forming apparatus comprising:
a modem unit for modulating a signal and converting and outputting the signal in a digital form;
a level controller for varying the voltage level of the signal output from the modem unit;
a line unit for detecting the voltage level of the signal comprising the varied voltage level and transmitting the signal comprising the varied voltage level to an external device through a public switched telephone network (PSTN); and
a controller for adjusting the voltage level of the signal output from the modem unit by controlling the level controller according to the result of the comparison between the voltage level value of the signal detected by-the line unit and a reference value.

2. The apparatus as claimed in claim 1, wherein the signal comprises at least one of a clock signal and a data signal to be transmitted to the external device.

3. The apparatus as claimed in claim 2, wherein the modem unit comprises:
a modem for modulating a data signal to be transmitted to the external device; and
a line interface for converting and outputting the modulated signal in a digital form.

4. The apparatus as claimed in claim 1, further comprising a data transmission unit for transmitting the signal between the modem unit and the line unit.

5. The apparatus as claimed in claim 1, further comprising a storage unit for storing the reference value.

6. The apparatus as claimed in claim 1, wherein the line unit comprises:
a voltage detector for detecting the voltage level value of the signal comprising the varied voltage level; and
a transceiver for sending and receiving the signal comprising the varied voltage level from the external device through a PSTN.

7. The apparatus as claimed in claim 1, wherein the level controller comprises a variable resistor for varying the voltage level of the signal output from the modem unit.

8. The apparatus as claimed in claim 7, wherein the controller increases the voltage level value of the signal output from the modem unit by decreasing the resistance value of the variable resistor if the voltage level value of the signal detected by the voltage detector is less than the reference value.

9. The apparatus as claimed in claim 7, wherein the controller decreases the voltage level value of the signal output from the modem unit by increasing the resistance value of the variable resistor if the voltage level value of the signal detected by the voltage detector is greater than the reference value.

10. A method of controlling an image forming apparatus comprising steps of:
detecting a voltage level of a signal, the signal being modulated by a modem unit and converted and output in a digital form; and
adjusting the voltage level of the signal according to a result of a comparison between the detected voltage level value and a reference value.

11. The method as claimed in claim 10, wherein the signal comprises at least one of a clock signal and a data signal to be transmitted to an external device.

12. The method as claimed in claim 10, wherein the voltage level of the signal varies according to a change of resistance value of a variable resistor.

13. The method as claimed in claim 12, wherein the step of adjusting the voltage level of the signal comprises steps of:
increasing the voltage level value of the signal by decreasing the resistance value of the variable resistor if the detected voltage level value is less than the reference value; and
decreasing the voltage level value of the signal by increasing the resistance value of the variable resistor if the detected voltage level value is greater than the reference value.
